(19) United States
(12) Patent Application Publication
(10) Pub. No.: US 2026/0131257 A1
(43) Pub. Date: May 14, 2026

(54) Pinwheel

(71) Applicant: Shijia Chen, Xiamen (CN)

(72) Inventor: Shijia Chen, Xiamen (CN)

(21) Appl. No.: 19/031,077

(22) Filed: Jan. 17, 2025

(30) Foreign Application Priority Data
Nov. 13, 2024 (CN) 202422763092.0

(51) Int. Cl. A63H 33/40; F21V 33/00

(52) U.S. Cl. CPC A63H 33/40; F21V 33/008

(57) ABSTRACT

Please replace the abstract with the following:
A pinwheel is provided that includes a central member with a first end. One or more rotating members are connected to and rotatable around the central member. A swingable member mounted at and swingable with respect to the first end.

### CROSS-REFERENCE TO RELATED APPLICATIONS

This application claims priority to Chinese Patent Application No. CN 202422763092.0, filed on Nov. 13, 2024 and entitled “pinwheel”. The disclosure of the aforementioned application is hereby incorporated herein by reference in its entirety.

### TECHNICAL FIELD

The present disclosure relates to the technical field of amusement and ambience decoration, and particularly, to a pinwheel.

### BACKGROUND

As a favorite amusement and ambience decoration items, pinwheels are loved by people, especially children. A pinwheel can either be held in hand as a hand-held toy or installed at somewhere as a decorative item. A conventional pinwheel generally has a central member (e.g., a central shaft) and several rotating members (e.g., blades) connected to the central member. The rotating members are able to rotate around the central member to create playfulness. In a typical scenario, for example, the blades of a pinwheel are able to rotate against the wind. In order to improve the playfulness of the pinwheel, there is a technical solution in the prior art that adds light sources to the pinwheel to make the pinwheel have luminous effects. Nevertheless, how to further improve the playfulness of pinwheels is still a problem that those skilled in the art need to solve.

### SUMMARY

This and other problems are generally solved or circumvented, and technical advantages are generally achieved, by embodiments of the present disclosure which provide pinwheels.

### TECHNICAL PROBLEMS

The present disclosure provides pinwheels to improve the playfulness of pinwheels.

### TECHNICAL SOLUTIONS

A pinwheel provided in the present disclosure may include a central member, several rotating members and a swingable member in front of the rotating members, where the swingable member is connected to the central member and is swingable. The swing of the swingable member increases the playfulness of the pinwheel.

The central member and the rotating members may be constructed by imitating those in the prior art. The central member is generally linear and with two ends distributed in the longitudinal direction of it. The swingable member is arranged at one of the two ends. Its swing may be casual, irregular and natural. The rotating members are generally arranged between the two ends of the central member and they generally rotate around the central member and in a rotation plane perpendicular to the longitudinal direction of the central member.

In a possible embodiment, the swingable member is connected to the central member through a connection mechanism realizing the swing of the swingable member. The connection mechanism may include a block and a seat which are connected to the central member and the swingable member, respectively. The seat is provided with a constraint cavity, in which the block is arranged. The connection mechanism realizes the swing of the swingable member with a simple structure, and because the block can have many degrees of freedom, various forms of swing of the swingable member, as well as the casual, irregular and natural swing mentioned above, can be realized.

Optionally, a line defined by the center of the block and the center of gravity of the swingable member is perpendicular to a longitudinal axis of the central member. The projection of the center of the block on a plane parallel to the longitudinal axis of the central member and perpendicular to the line or the projection of a contacting end that is arranged on the block and is for contacting with the wall of the constraint cavity on the plane coincides with the projection of the center of gravity of the swingable member on the plane. In this way, the swingable member can swing by using its own weight, thus there can be no need to specially supply a driver for driving the swingable member to swing.

In a possible embodiment, the center of the swingable member is aligned with the central member.

Optionally, each rotating member is blade-shaped and in the front view of the pinwheel, the swingable member is circular or regular polygonal. The ends of the rotating members away from the central member are exposed from, distributed along and evenly surround the periphery of the swingable member. In this way, a structure like a sunflower disc is formed which can increase the playfulness of the pinwheel. The swingable member is like a central part of the sunflower disc and the exposed ends of the rotating members are like petals of the sunflower disc.

In a possible embodiment, the swingable member is plate-shaped and protrudes towards the front of the pinwheel to form an accommodating space with an opening towards the rear of the pinwheel. In this way, the connection structures of the swingable member and the central member can be arranged in the accommodating space to be basically occluded by the swingable member and the rotating members, thus being basically hidden and not exposed in people's vision to avoid adversely affecting the appearance of the pinwheel.

In a possible embodiment, the pinwheel provided in the present disclosure may be provided with a light source and the central member, the swingable member and/or the rotating members is(are) made at least partly of light-penetrable material. In this way, the pinwheel has a luminous effect thus increasing the playfulness thereof.

In a possible embodiment, the pinwheel provided in the present disclosure may be provided with an inserting connection assembly, where the center of the inserting connection assembly is connected to the central member, and the inserting connection assembly is provided with slots which are distributed along the periphery of the inserting connection assembly and corresponding one-to-one with the rotating members. The second end of each rotating member close to the central member is inserted into a corresponding slot. In this way, in the rear view of the pinwheel, the inserting connection assembly and the rotating members form a flower-like structure thus the playfulness of the pinwheel is increased.

Optionally, various pattern of people or animal expression may be arranged on the front surface of the swingable member. In this way, when the rotating members rotate and the swingable member swings in the use process of the pinwheel, the whole pinwheel is like a vivid living flower, such that the playfulness of the pinwheel is effectively increased.

### BRIEF DESCRIPTION OF THE DRAWINGS

In order to more clearly illustrate the technical solutions in the embodiments of the present disclosure, the accompanying drawings to be used in the descriptions of the embodiments or the prior art will be briefly described below. It is easy to understand that the accompanying drawings are only used to describe the embodiments of the present disclosure, and are not intended to limit the present disclosure. For a person of ordinary skill in the art, without involving any inventive effort, other accompanying drawings which should be included within the protection scope of the present disclosure may be obtained according to these accompanying drawings.

FIG. 1 is a first schematic perspective view of a pinwheel according to embodiments of the present disclosure;

FIG. 2 is a schematic side view of a pinwheel according to embodiments of the present disclosure;

FIG. 3 is a first schematic longitudinal sectional view of a pinwheel according to embodiments of the present disclosure, where a section plane passes through the center of the pinwheel and extends along the front-rear direction and the up-down direction, and a swingable member is connected to a central member through a first connection mechanism;

FIG. 4 is a second schematic longitudinal sectional view of a pinwheel according to embodiments of the present disclosure, where a section plane passes through the center of the pinwheel and extends along the front-rear direction and the up-down direction, and a swingable member is connected to a central member through a resilient element;

FIG. 5 is a third schematic longitudinal sectional view of a pinwheel according to embodiments of the present disclosure, where a section plane passes through the center of the pinwheel and extends along the front-rear direction and the up-down direction, and a swingable member is connected to a central member through a third connection mechanism;

FIG. 6 is an enlarged view of the first connection mechanism in FIG. 3;

FIG. 7 is an enlarged view of the third connection mechanism in FIG. 5;

FIG. 8 is a cross-section along a section line A-A according to FIG. 7;

FIG. 9 is a further enlarged view of the first connection mechanism according to FIG. 6;

FIG. 10 is a schematic longitudinal sectional view of a connection mechanism, the block of which, compared with the block in FIG. 9, is without a blocking part;

FIG. 11 is a schematic longitudinal sectional view of a fourth connection mechanism, where for clarity, hatch patterns are omitted;

FIG. 12 is a schematic longitudinal sectional view of a fifth connection mechanism, where for clarity, hatch patterns are omitted;

FIG. 13 is a schematic longitudinal sectional view of a sixth connection mechanism, where for clarity, hatch patterns are omitted;

FIG. 14 is a fourth schematic longitudinal sectional view of a pinwheel according to embodiments of the present disclosure, where a section plane passes through the center of the pinwheel and extends along the front-rear direction and the up-down direction;

FIG. 15 is an enlarged view of a part E in FIG. 14;

FIG. 16 is a schematic perspective view of connection structures of a swingable member and a central member of a pinwheel according to embodiments of the present disclosure, where a back of the swingable member and a front part of the central member are shown;

FIG. 17 is an enlarged view of a part B in FIG. 16;

FIG. 18 is a first schematic front view of a pinwheel according to embodiments of the present disclosure, where a swingable member is circular;

FIG. 19 is a second schematic front view of a pinwheel according to embodiments of the present disclosure, where a swingable member is regular polygonal;

FIG. 20 is a fifth schematic longitudinal sectional view of a pinwheel according to embodiments of the present disclosure, where a section plane passes through the center of the pinwheel and extends along the front-rear direction and the up-down direction;

FIG. 21 is a sixth schematic longitudinal sectional view of a pinwheel according to embodiments of the present disclosure, where a section plane passes through the center of the pinwheel and extends along the front-rear direction and the up-down direction;

FIG. 22 is a seventh schematic longitudinal sectional view of a pinwheel according to embodiments of the present disclosure, where a section plane passes through the center of the pinwheel and extends along the front-rear direction and the up-down direction;

FIG. 23 is a longitudinal section along a section line C-C according to FIG. 22;

FIG. 24 is an enlarged view of a part D in FIG. 23;

FIG. 25 is an eighth schematic longitudinal sectional view of a pinwheel according to embodiments of the present disclosure, where a section plane passes through the center of the pinwheel and extends along the front-rear direction and the up-down direction, and a light source is arranged on the front end of a central member;

FIG. 26 is a second schematic perspective view of a pinwheel according to embodiments of the present disclosure, where the pinwheel is provided with an inserting connection assembly;

FIG. 27 is a schematic perspective view of the inserting connection assembly in FIG. 26;

FIG. 28 is a schematic perspective view of eight rotating members and the inserting connection assembly in FIG. 27, where the rotating members are inserted into slots of the inserting connection assembly along the radial direction of the inserting connection assembly;

FIG. 29 is a first exploded view of an inserting connection assembly of a pinwheel according to embodiments of the present disclosure;

FIG. 30 is a second exploded view of an inserting connection assembly shown in FIG. 29;

FIG. 31 is a schematic perspective view of one rotating member of a pinwheel according to embodiments of the present disclosure; and

FIG. 32 is a ninth schematic longitudinal sectional view of a pinwheel according to embodiments of the present disclosure, where a section plane passes through the center of the pinwheel and extends along the front-rear direction and the up-down direction, and the pinwheel includes a motor.

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION OF ILLUSTRATIVE EMBODIMENTS

Illustrative embodiments of the present disclosure are described in detail below referring to the drawings. It should be understood that the embodiments and the drawings are only for illustrating technical problems, technical solutions and advantageous effects of the present disclosure and they cannot be regarded as any limitation of protection scope of the present disclosure.

Embodiments of the present disclosure will be described in the following in a specific context, namely, a pinwheel. The disclosure, however, may be applied to a variety of devices with similar structures in the fields of amusement and decoration, including but not limited to, windmills, wind spinners, and wind sculptures, without departing from the principle and spirit of the present disclosure.

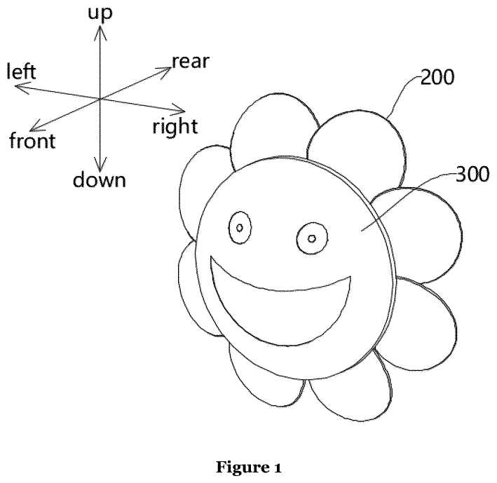

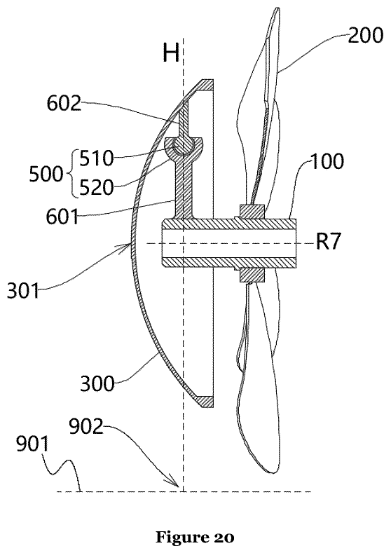

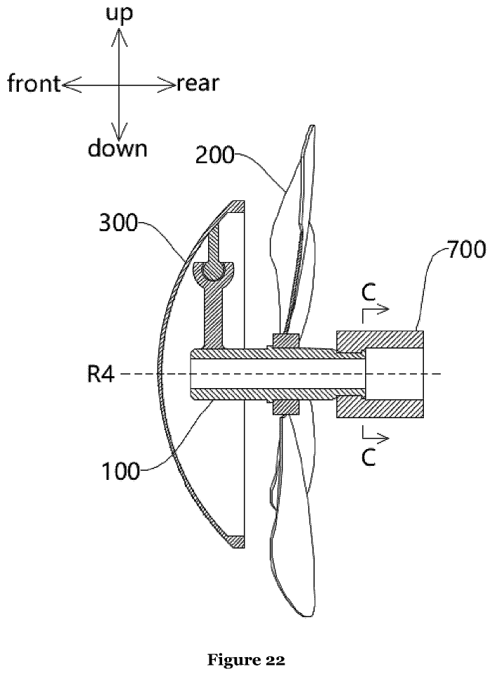

In the present disclosure, the directions and positional relationships indicating by the terms such as “front”, “rear”, “left”, “right”, “up”, “down” and the like are based on the pinwheel shown in FIG. 1. Referring to FIG. 1, the term “front” indicates one direction towards which the rotation axis (e.g., the axis R7 in FIG. 20 and the axis R4 in FIG. 22) of the rotating members extends (the rotation axis is a line extending towards two directions), and correspondingly, the term “rear” indicates the opposite direction which is the other direction the rotation axis extends towards. That is, the rotation axis of the rotating members extends along the front-rear direction of the pinwheel. The terms “front”, “rear”, “left” and “right” all indicate horizontal directions. The terms “up” and “down” both indicate vertical directions. The directions can be shown in a three-dimensional Cartesian coordinate system, as shown in FIG. 1. The direction terms and coordinate systems in the present disclosure are intended only to simplify description and make description clear, and they cannot be regarded as any limitation of protection scope of the present disclosure.

In addition, the terms “first”, “second” and the like in the present disclosure are only used to distinguish different features, and do not indicate limitations of the number and sequence of features. These term also cannot be regarded as any limitation of protection scope of the present disclosure.

### Embodiment 1

Please refer to FIGS. 1 to 3, the pinwheel provided by the present disclosure may include a central member 100, one or more rotating members 200 and a swingable member 300 in front of the rotating members 200, where the swingable member 300 is connected to the central member 100 and is swingable.

Compared with the prior art, the advantageous effect of the pinwheel provided in the present embodiment is that the swingable member 300 is provided, which is in front of the rotating members 200. The swing of the swingable member 300 increases the playfulness of the pinwheel.

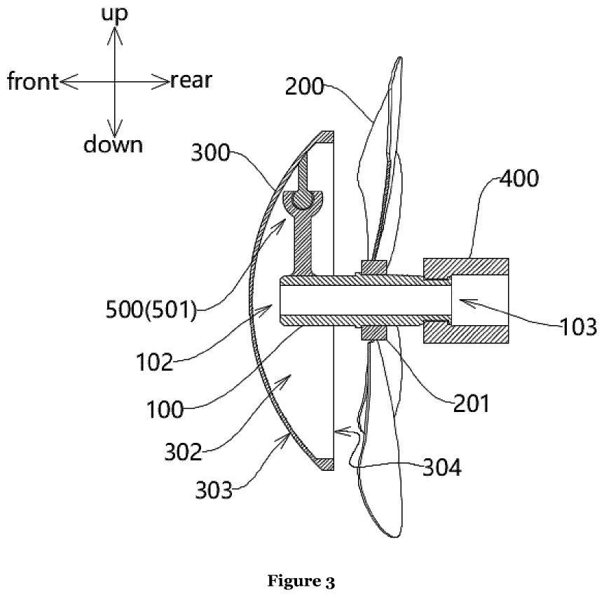

In the present embodiment, the central member includes two ends distributed along the front-rear direction of the pinwheel, where the front end 102 of the central member 100 shown in FIG. 3 can be defined as a first end and the rear end 103 of the central member 100 shown in FIG. 3 can be defined as a second end. The swingable member 300 is mounted at the first end of the central member 100, and is swingable with respect to the first end of the central member 100, as well as with respect to the central member 100 and the rotating members 200. The rotating members 200 are arranged between the swingable member 300 and the second end of the central member 100. The rotating members 200 rotates around the central member 100.

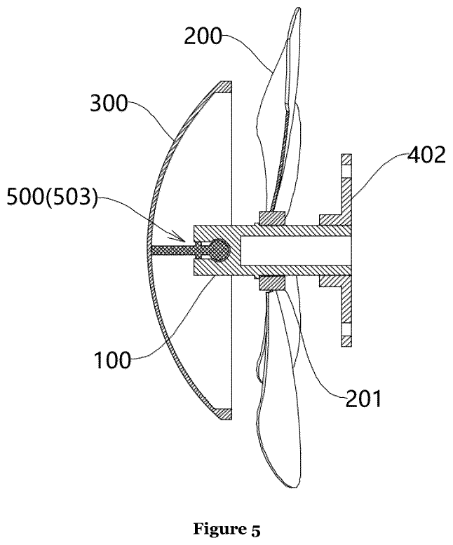

In Embodiment 1, it is not limited that how to achieve the swing of the swingable member 300. There are many ways by which the swing of the swingable member 300 can be achieved. For example, as shown in FIGS. 3 and 5, the swingable member 300 may be connected to the central member 100 through a first connection mechanism 501 or a third connection mechanism 503, such that the swing of the swingable member 300 is achieved. The first connection mechanism 501 and the third connection mechanism 503 will be described further below.

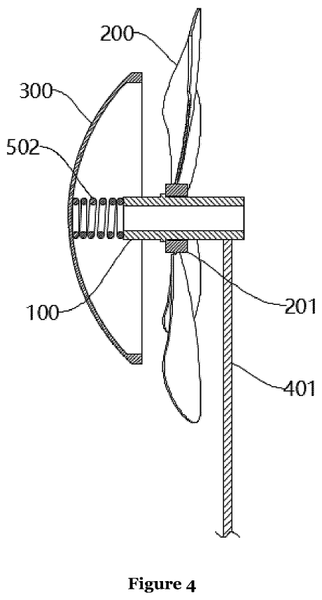

In another example, as shown in FIG. 4, the swingable member 300 may also be connected to the central member 100 through a resilient element (e.g., the spring 502), such that the swing is achieved. In this example, when the swingable member 300 is not touched, it remains in the state shown in FIG. 4. Once touched, the external force deforms the spring 502, and after the external force disappears, the swingable member 300 swings under the action of the elastic force of the spring 502.

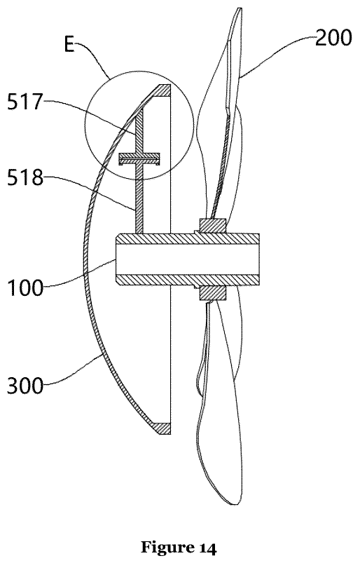

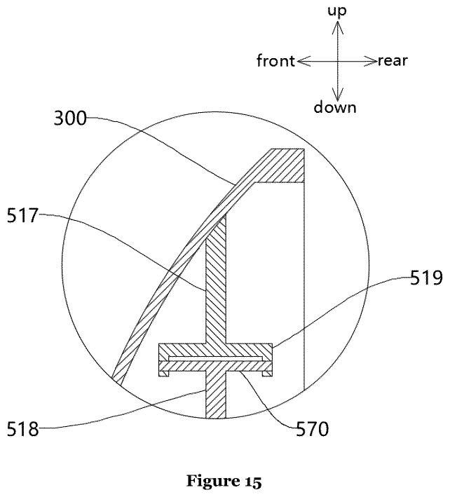

In another example, the swing of the swingable member 300 may be achieved through the structures shown in FIGS. 14 and 15. In this example, the swingable member 300 is connected to the central member 100 through a first vertical rod 517 and a second vertical rod 518. The upper end of the first vertical rod 517 is connected to the upper part of the back of the swingable member 300. The lower end of the first vertical rod 517 is provided with a connection block 519. The lower end of the second vertical rod 518 is connected to the central member 100. The upper end of the second vertical rod 518 is provided with a horizontal rod 570. The horizontal rod 570 is rotatably connected to the connection block 519 to achieve the swing of the swingable member 300. As shown in FIG. 15, the horizontal rod 570 may extend in the front-rear direction, in this case, seen from the front of the pinwheel, the swingable member 300 swings left and right. In a variant of this example, the horizontal rod may extend in the left-right direction, in this case, the swingable member 300 swings front and rear.

Generally, the central member 100 may be shaft-shaped. The central member 100 may be a solid shaft or a hollow shaft. The central member 100 itself may not be rotated, also may be rotated. Both the rotating members 200 and the swingable member 300 are connected to the central member 100, and the swingable member 300 is in front of the rotating members 200, such that, seen from the front of the pinwheel, not only the rotation of the rotating members 200 is playful, but also the swing of the swingable member 300 can increase the playfulness of the pinwheel.

In Embodiment 1, the shape and structure of each rotating member 200 is not limited. The rotating member 200 may be the blades shown in FIGS. 1 to 5, or any blade in the prior art. Exemplarily, as shown in FIGS. 3 to 5, the rotating members 200 may be connected to the central member 100 through a first connector 201. The first connector 201 may be a bearing, the inner ring of which may be fixedly connected to the central member 100, and the outer ring of which may be fixedly connected to the rotating members 200.

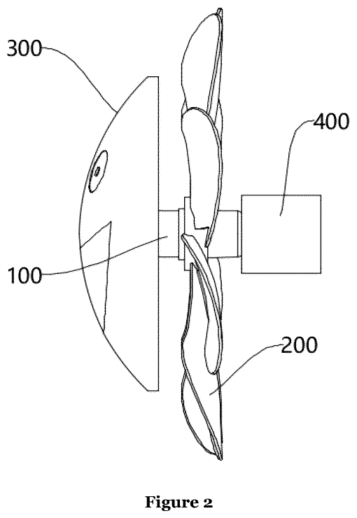

In Embodiment 1, it is not limited that whether the rotating members 200 are separated from each other or connected to form a one-piece structure. The rotating members 200 may be separated from each other, as shown in FIG. 2. The rotating members 200 also may be connected to each other to form a one-piece structure, for example, the rotating members 200 may be manufacturing as a one-piece member by injection molding method. Generally, when the rotating members 200 are separated from each other, the number of the rotating members 200 is two or more. When the separated rotating members are connected to each other forming a one-piece structure, this one-piece structure can be regarded as one rotating member. Therefore, the number of the rotating member may be one.

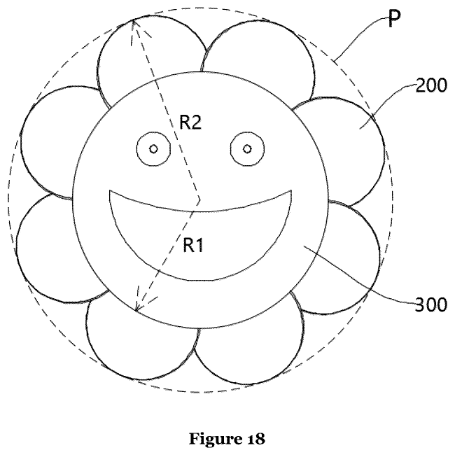

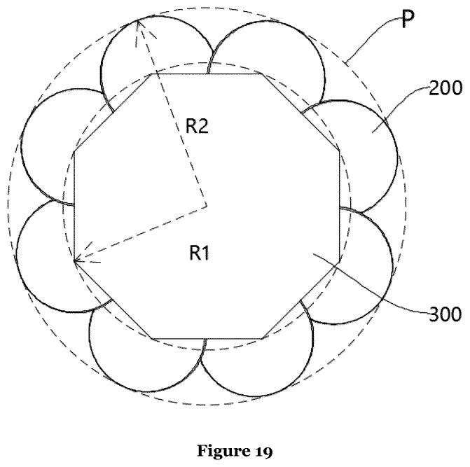

Exemplarily, as shown in FIGS. 1, 18 and 19, each rotating member 200 may be blade-shaped, and, in the front view of the pinwheel (referring to FIG. 3, when seen along a direction from the swingable member 300 toward the second end 103 of the central member 100), the swingable member 300 is circular (as shown in FIG. 18) or regular polygonal (as shown in FIG. 19). The radius R1 of the swingable member 300 is smaller than the radius R2 of the circular rotation path P of the first end (which is away from the central member) of each rotating member 200, such that, the first ends of the rotating members 200 can be exposed from the periphery of the swingable member 300. It should be noted that when it is regular polygonal, the radius of the swingable member 300 refers to the radius of its circumcircle, as shown in FIG. 19. In this example, the number of sides of the regular polygon of the swingable member 300 may be any positive integer not less than 3.

In this example, the outer end (that is, the first end which is away from the central member) of each rotating member 200 is not occluded by the swingable member 300, such that, a structure like a flower disc of a sunflower is formed. This structure brings playfulness to the pinwheel. In this structure, the swingable member 300 forms the central part of the flower disc and all the first ends of the rotating members 200, which can be distributed along the periphery of the swingable member 300 and evenly surround the swingable member 300, forms the petals of the flower disc. In addition, the surface of the swingable member 300 may be provided with various expressions, such as the smiling face shown in FIGS. 1 and 18, such that the pinwheel is more relatable and infectious and the playfulness of the pinwheel is further improved.

In Embodiment 1, the materials of the central member 100, the rotating members 200, and the swingable member 300 are not limited. Exemplarily, they may be made of plastic materials or other materials, such as metal or cardboard.

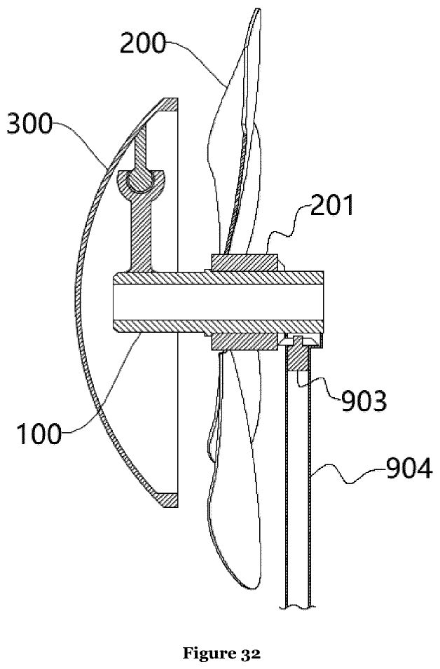

In Embodiment 1, it is not limited that whether the rotating members 200 is driven by a driver or by natural wind. The pinwheel provided in the present disclosure may include a driver for driving the rotating members 200 to rotate. The driver may be a motor. As shown in FIG. 32, a motor 903 may be arranged in a rod 904 for hand holding. The rotating members 200 are connected to the central member 100 through a first connector 201. The output shaft of the motor 903 is connected to the first connector 201 through a pair of bevel gears, one of which is fixed to the output shaft of the motor 903 and the other one of which is fixed to the first connector 201. Thus, the motor 903 can drive the first connector 201 and the rotating members 200 to rotate. The pinwheel may not include a driver for driving the rotating members 200 to rotate. In this condition, the rotating members 200 can rotate blown by wind.

In Embodiment 1, it is not limited that whether or how the pinwheel is fixed to an external object. Exemplarily, as shown in FIGS. 2 and 3, the pinwheel may be fixed to an external object, such as the top of a fence in a playground or kindergarten, through a second connector 400 that is sleeve-like and arranged on the central member 100. As shown in FIG. 4, the central member 100 may be provided with a rod 401 for handholding that is below the central member 100. As shown in FIG. 5, a flange 402 may be arranged at the rear end of the central member 100 to be connected to an external object.

### Embodiment 2

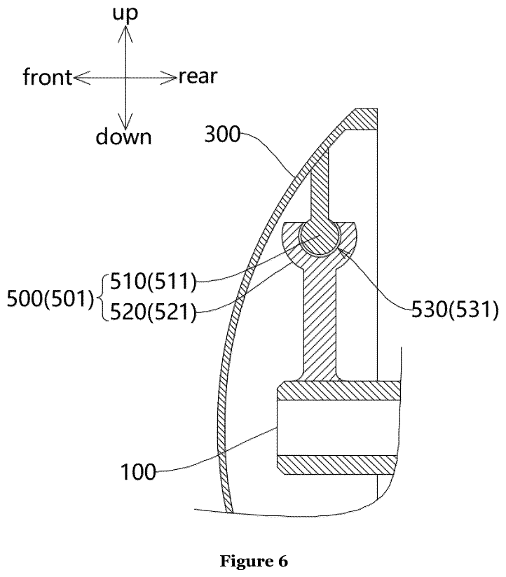

Please referring to FIGS. 3 and 5, the swingable member 300 may be connected to the central member 100 through a connection mechanism 500 to realize the swing of the swingable member 300. As shown in FIGS. 6 to 13, the connection mechanism 500 may include a block 510 and a seat 520. The block 510 is connected to one of the central member 100 and the swingable member 300 (in FIGS. 6 to 13, the block 510 is connected to the swingable member 300), and the seat 520 is connected to the other one of the central member 100 and the swingable member 300 (in FIGS. 6 to 13, the seat 520 is connected to the central member 100). The seat 520 is provided with a constraint cavity 530. The block 510 is arranged in the constraint cavity 530 and the block 510 is not fixed. For example, the block 510 may be rotatable and/or movable.

In the present embodiment, a structure achieving the swing of the swingable member 300 is provided. In this structure, the block 510 is arranged in the constraint cavity 530 and the block 510 is not fixed. And, the swingable member 300 and the central member 100 are connected, respectively, to the block 510 and the seat 520, such that, the swingable member 300 is not fixed relative to the central member 100 and the swing of the swingable member 300 can be achieved. The structure for achieving the swing of the swingable member 300 provided in the present embodiment is simple, and the block 510 may be with many freedoms to achieve swing with various of forms.

In the present embodiment, the shapes of the block 510, the seat 520, the constraint cavity 530 and the opening of the constraint cavity 530 are not limited. For the block 510 and the constraint cavity 530, they may be with various shapes, as long as the block 510 can be constrained in the constraint cavity 530 and the block 510 is not fixed relative to the seat 520.

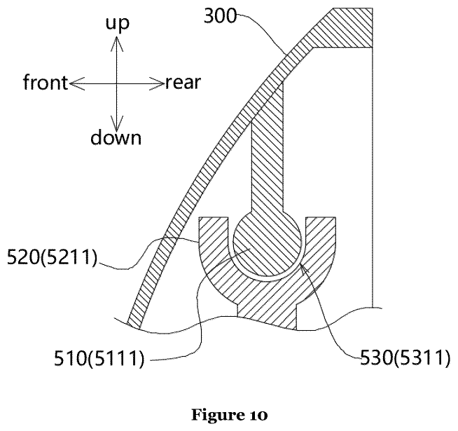

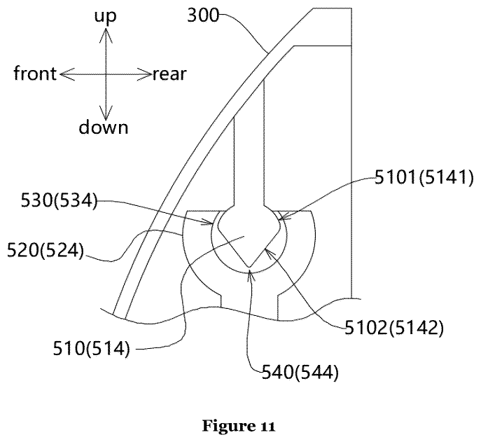

In the present embodiment, the block 510 may be provided with a blocking part 5101 (as shown in FIGS. 11 to 13), or may be not provided with the blocking part (as shown in FIG. 10). When the blocking part is not provided, as shown in FIG. 10, the block 510 may be placed, from up to down, into the constraint cavity 530 which is with an opening facing upwards. Although the constraint cavity 530 can only limit the block 510 from moving in horizontal directions and moving downward (when subjected to an upward external force, the block 510 will move upwards and leave the constraint cavity 530), the block 510 can remain in the constraint cavity 530 to realize the swing of the swingable member 300, as long as the block 510 and the seat 520 remain in the state shown in FIG. 10.

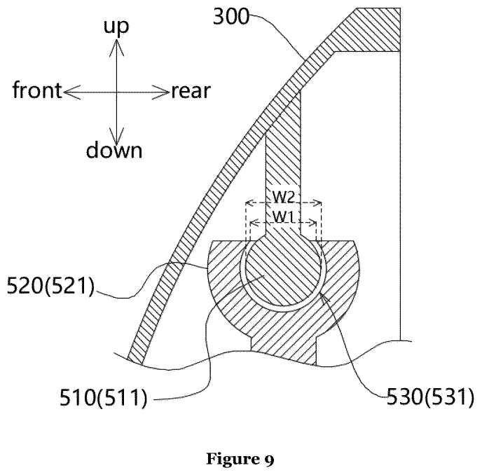

When the blocking part 5101 is provided, as shown in FIGS. 11 to 13, the blocking part 5101 can prevent the block 510 from detaching from the constraint cavity 530 from the opening of the constraint cavity 530. Exemplarily, as shown in FIG. 9, when the opening of the constraint cavity 530 is circular and the block 510 is spherical, the diameter W1 of the opening may be arranged to be smaller than the diameter W2 of the block 510, thus the upper part of the block 510 can be used as the blocking part to prevent the block 510 from detaching from the opening of the constraint cavity 530.

Exemplarily, five examples of the connection mechanism 500 are shown in FIGS. 6 to 13 and they are described as follows.

FIGS. 6 and 9 show a first connection mechanism 501 which includes a first block 511 and first seat 521. The first seat 521 is provided with a first constraint cavity 531. Both the first block 511 and the first constraint cavity 531 are spherical. The upper part of the first block 511 can be used as the blocking part to prevent the first block 511 from detaching from the first constraint cavity 531.

FIG. 10 shows a variant of the first connection mechanism 501 which includes a second block 5111 and a second seat 5211. The second seat 5211 is provided with a second constraint cavity 5311. The second block 5111 is spherical. The longitudinal section of the second constraint cavity 5311 is U-shaped. The diameter of the second block 5111 is not more than the diameter of the opening of the second constraint cavity 5311. The second block 5111 is without the blocking part.

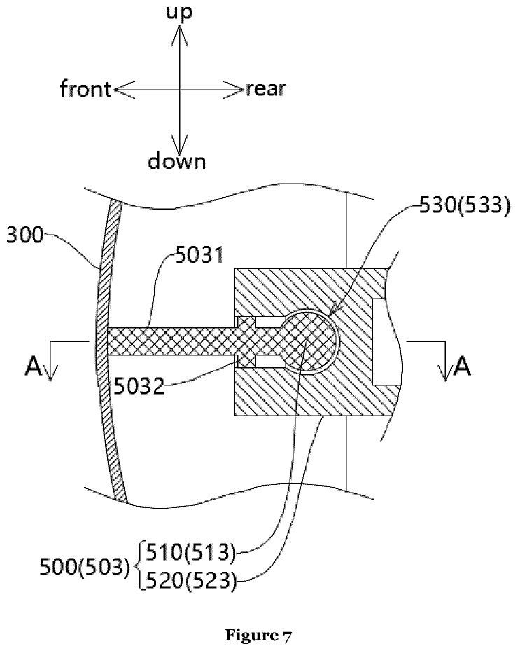

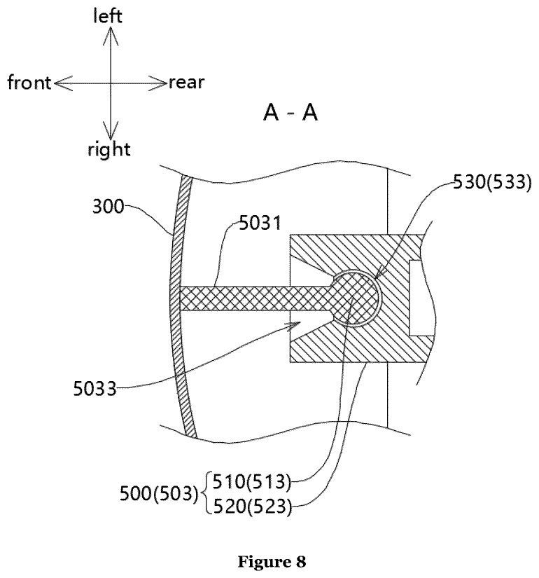

FIGS. 7 and 8 show a third connection mechanism 503 which includes a third block 513 and a third seat 523. The third seat 523 is provided with a third constraint cavity 533. Both the third block 513 and the third constraint cavity 533 are spherical. The part of the third block 513 close to the opening of the third constraint cavity 533 can be used as the blocking part to prevent the third block 513 from detaching from the third constraint cavity 533. The third connection mechanism 503 will be described further below.

FIG. 11 shows a fourth connection mechanism which includes a fourth block 514 and a fourth seat 524. The fourth seat 524 is provided with a fourth constraint cavity 534. The upper part of the fourth block 514 is a fourth blocking part 5141 which is spherical. The lower part of the fourth block 514 is a fourth conical part 5142. The fourth constraint cavity 534 is spherical.

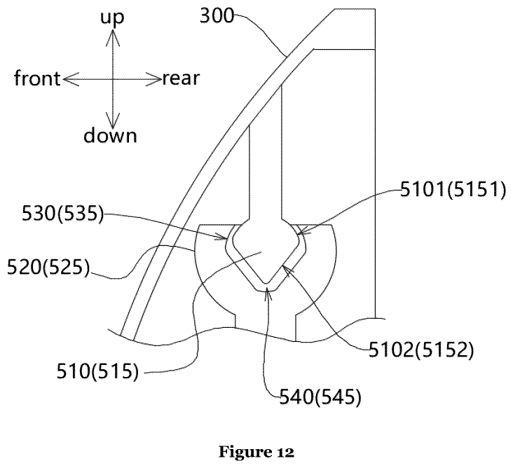

FIG. 12 shows a fifth connection mechanism which includes a fifth block 515 and a fifth seat 525. The fifth seat 525 is provided with a fifth constraint cavity 535. The upper part of the fifth block 515 is a fifth blocking part 5151 which is spherical. The lower part of the fifth block 515 is a fifth conical part 5152. The upper part of the fifth constraint cavity 535 is spherical and the lower part of the fifth constraint cavity 535 is conical. In the present example, a gap may be arranged between the fifth conical part 5152 and the wall of the lower part of the fifth constraint cavity 535 or not. When there is the gap, the fifth block 515 can both rotate and move. When there is no gap, the fifth block 515 can only rotate about its own axis.

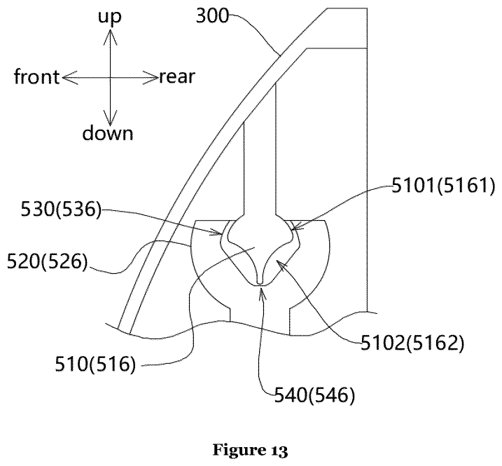

FIG. 13 shows a sixth connection mechanism which includes a sixth block 516 and a sixth seat 526. The sixth seat 526 is provided with a sixth constraint cavity 536. The upper part of the sixth block 516 is a sixth blocking part 5161 which is spherical. The lower part of the sixth block 516 is a concave 5162. The upper part of the sixth constraint cavity 536 is spherical and the lower part of the sixth constraint cavity 536 is conical. It is easy to understand that the concave 5162 may be of other shapes in addition to the shape shown in FIG. 13.

In Embodiment 2, the direction and the amplitude of the rotating of the block 510 is not limited. Taking the third connection mechanism 503 shown in FIGS. 7 and 8 as an example, the direction and the amplitude of the rotating of the block 510 may be controlled through the following way. A conical groove 5033 communicating with the constraint cavity 530 may be formed in the seat 520. The block 510 may be connected to the swingable member 300 through a horizontal rod 5031 passing through the conical groove 5033. The part of the horizontal rod 5031 close to the block 510 is in the conical groove 5033. In this way, the horizontal rod 5031 can swing horizontally, and the swing angle is limited by the inner walls of the conical groove 5033. In the vertical direction, the horizontal rod 5031 may be provided with two cushion blocks 5032 which are above and below the horizontal rod 5031, respectively. The two cushion blocks 5032 are in contact with the upper wall and the lower wall of the conical groove 5033, respectively, so that the horizontal rod 5031 cannot move up and down. That is to say, in the structures shown in FIGS. 7 and 8, the block 510 only can rotate horizontally, and correspondingly, the swingable member 300 only swings horizontally in a certain angle.

In Embodiment 2, the setting position of the connection mechanism 500 is not limited. The connection mechanism 500 may be arranged in different positions, as shown in FIGS. 3 and 5. In FIG. 3, the first connection mechanism 501 is arranged at the upper part of the swingable member 300. In FIG. 5, the third connection mechanism 503 is arranged at the middle part of the swingable member 300.

### Embodiment 3

Please referring to FIGS. 11 to 13, the block 510 may be provided with a contacting end 540 contacting the constraint cavity 530. The contacting end 540 is in contact with the wall of the constraint cavity 530 in a small area. The contact between the contacting end 540 and the wall of the constraint cavity 530 may be point contact, line contact or surface contact with small contacting area. In FIGS. 11 to 13, the fourth block 514, the fifth block 515 and the sixth block 516 are provided with a fourth contact end 544, a fifth contact end 545 and a sixth contact end 546, respectively. The blocks 510 shown in FIGS. 6 to 10 are spherical, and they are in surface contact with the wall of the constraint cavity 530, and the contact area is large. In contrast, the block 510 in the present embodiment is provided with the contacting end 540, the contacting area of which with the wall of the constraint cavity 530 is very small, so that the friction between the block 510 and the wall of the constraint cavity 530 can be reduced and the flexibility of the block 510 is improved.

The structure provided in the present embodiment is particularly suitable for the situation that, when the pinwheel is static, the projection of the center of gravity of the swingable member 300 on a plane 901 parallel to a longitudinal axis R7 of the central member 100 (shown in FIG. 20) coincides with the projection of the contacting end 540 on the plane 901. In this situation, the contacting end 540 can press on the bottom of the constraint cavity 530 relying on the gravity of the swingable member 300 while the bottom of the constraint cavity 530 supports the block 510 and the swingable member 300 connected to the block 510. In this way, the swingable member 300 can swing using its own gravity, and if even there is no driver specially arranged for driving the swingable member 300 to swing, the swingable member 300 may swing using its own gravity. It will be further described below that the situation that the swingable member 300 swings using its own gravity.

### Embodiment 4

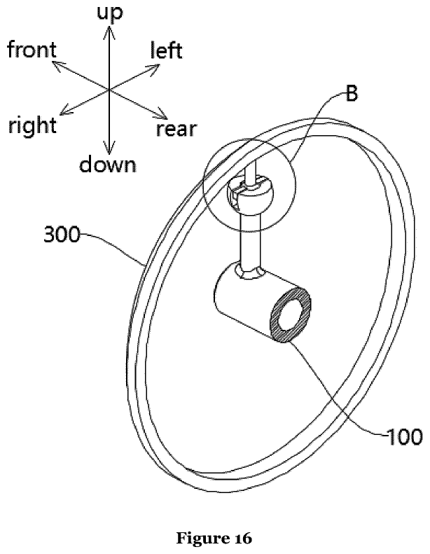

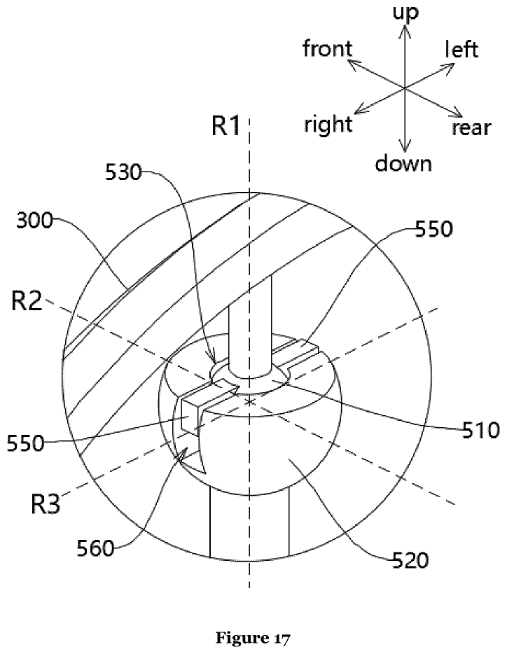

Please referring to FIGS. 16 and 17, the block 510 may be provided with several limiting blocks 550, and the seat 520 may be provided with several limiting grooves 560 corresponding one-to-one with the limiting blocks 550. Each of the limiting blocks 550 is arranged in a corresponding limiting groove 560 of the several limiting grooves 560 to limit the rotating amplitude and/or the moving amplitude of the block 510 arranged in the constraint cavity 530, such that the swing amplitude of the swingable member 300 is limited. Compared with the structure shown in FIGS. 7 and 8, the present embodiment provides another structure for controlling the direction and the amplitude of the rotation of the block 510. In the present embodiment, the block 510 has more degrees of freedom and the rotation amplitude of each degree of freedom of the block 510 can be controlled.

As shown in FIG. 17, in the present embodiment, when the constraint cavity 530 is opened upwards, the limiting groove 560 may be opened upwards, extended in the left-right direction and in communication with the constraint cavity 530. Correspondingly, the limiting blocks 550 are arranged at the left side and/or the right side of the block 510. A gap is arranged between the limiting block 550 and the bottom wall of the limiting groove 560, therefore, the block 510 can rotate about the axis R2 extending in the front-rear direction, such that the left and right ends of the swingable member 300 can swing up and down. Two gaps are arranged between the limiting block 550 and the front and the rear side walls of the limiting groove 560, therefore, the block 510 can rotate about the axis R3 extending in the left-right direction, and can also rotate about the axis R1 extending in the up-down direction. When the block 510 rotates about the axis R3, the upper and lower ends of the swingable member 300 swing front and rear, and a nodding effect of the swingable member 300 is formed. When the block 510 rotates about the axis R1, the left and right ends of the swingable member 300 swing front and rear, and a shaking head effect of the swingable member 300 is formed.

The rotation amplitude of the block 510 in each direction can be adjusted by changing the size of the corresponding gap(s) between the limiting blocks 550 and the corresponding wall(s) of the limiting grooves 560. In FIG. 17, the distance between the limiting blocks 550 and the bottom wall of the limiting grooves 560 is larger, and the distances between the limiting blocks 550 and the front and rear walls of the limiting grooves 560 are smaller. Therefore, the rotation amplitude of the block 510 about the axis R2 is larger, and the rotation amplitudes of the block 510 about the axis R3 and the axis R1 are smaller.

In Embodiment 4, the shape of the limiting block 550 is not limited. In FIG. 17, the limiting blocks 550 are rectangular blocks. It can be easily foreseen from FIG. 17 that the limiting block 550 may also be cylindrical. In the present embodiment, the number of the limiting blocks 550 are not limited. In FIG. 17, the number of limiting blocks 550 is two, and they are symmetrically distributed on the left and right sides of the blocks 510. It can be easily foreseen from FIG. 17 that the number of limiting blocks 550 and limiting grooves 560 may also be more, e.g. three or four. In the present embodiment, the extending direction of the limiting groove 560 is not limited. In FIG. 17, the limiting grooves 560 extend in the left-right direction. It can be easily foreseen from FIG. 17 that the limiting groove 560 can also extend in the front-rear direction.

### Embodiment 5

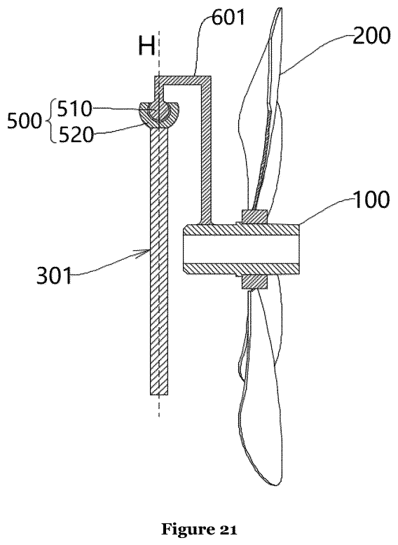

Please referring to FIGS. 20 and 21, the center 301 of the swingable member 300 may be aligned with the central member 100 as well as the center of the rotating members 200, such that the structure similar to a sunflower flower disc mentioned above can be formed to increase the playfulness of the pinwheel. Exemplarily, the center 301 of the swingable member 300 can be aligned with the central member 100 through the following structure: as shown in FIG. 20 and FIG. 21, the connection mechanism 500 may be connected to the central member 100 through a first connection rod 601, the connection mechanism 500 is above the central member 100, and the connection mechanism 500 is connected to the upper part of the swingable member 300.

In addition, optionally, in the present embodiment, referring to FIG. 20, when the pinwheel is static, a line H defined by the center of the block 510 and the center of gravity of the swingable member 300 is perpendicular to a longitudinal axis R7 of the central member 100, and the projection of the center of gravity of swingable member 300 on a plane 901 parallel to the longitudinal axis R7 and perpendicular to the line H may coincide with the projection of the center of the block 510 on the plane 901. They coincide at a point 902 on the plane 901. As shown in FIGS. 20 and 21, the center of gravity of swingable member 300 and the center of the block 510 are on the same vertical line H perpendicular both to the plane 901 and the longitudinal axis R7. In this way, the self-weight of the swingable member 300 can participate in the swing of the swingable member 300 (i.e., the situation that the swingable member 300 swings using its own gravity mentioned above). When not driven/pushed by any external force, the swingable member 300 remains in the static state shown in FIGS. 1, 20 and 21. When the center of gravity of the swingable member 300 deviates from the original position (e.g., when the swingable member 300 is blown by wind), the self-weight of the swingable member 300 will make the swingable member 300 to move to the original position, then the swingable member 300 will swing in a reciprocating manner (generally an irregular reciprocating), until the swingable member 300 returns to be static. The pinwheel provided in the present example does not need to be driven/pushed by a driver specially arranged for driving the swingable member 300 to swing, and the swingable member 300 of the pinwheel can swing, for example blown by natural wind or being shaken by a hand holding the pinwheel, so that the playfulness of the pinwheel is effectively increased.

In Embodiment 5, “the center 301 of the swingable member 300 is aligned with the central member 100” refers that, along the front-rear direction, the projection of the center 301 of the swingable member 300 on a vertical plane coincides with the projection of the central member 100 on the vertical plane. Preferably, the projection of the center 301 of the swingable member 300 on the vertical plane approximately coincides with the projection of the center of the central member 100 on the vertical plane.

In Embodiment 5, the lower end of the first connection rod 601 is connected to the central member 100, and the upper end of the first connection rod 601 is connected to the connection mechanism 500. It is not limited that the upper end of the first connection rod 601 is connected to which part of the connection mechanism 500. The upper end of the first connection rod 601 may be connected to the seat 520 (as shown in FIG. 20) or the block 510 (as shown in FIG. 21).

In Embodiment 5, it is not limited that how the connection mechanism 500 is connected to the swingable member 300. As shown in FIG. 20, the connection mechanism 500 may be used as a support structure to be connected to the upper part of the swingable member 300. As shown in FIG. 21, the connection mechanism 500 may also be used as a suspension structure to be connected to the top of the swingable member 300, while the swingable member 300 is hung below the connection mechanism 500. Correspondingly, the shape of the first connection rod 601 is not limited, for example, it may be linear as shown in FIG. 20 or L-shaped as shown in FIG. 21.

### Embodiment 6

Please referring to FIGS. 3, 4, 5, 14 and 20, the swingable member 300 may be plate-shaped and protrude anti-towards the rotating members 200 (i.e., towards the front of the pinwheel) to form an accommodating space 302 (shown in FIG. 3) with an opening towards the rotating members 200 (i.e., towards the rear of the pinwheel). In the present embodiment, as shown in FIG. 3, the swingable member 300 includes a first surface 303 and a second surface 304 forming the accommodating space 302 in-between, the first surface 303 is a convex surface curved away from the rotating members 200, and the second surface 304 faces the rotating members 200 and has an opening through which the first end 102 of the central member 100 extends into the accommodating space 302. Optionally, in the present embodiment, as shown in FIG. 20, the connection mechanism 500 may be connected to the swingable member 300 through a second connection rod 602. The second connection rod 602, the connection mechanism 500 and the first connection rod 601 can all be accommodated in the accommodating space 302.

In the present embodiment, the swingable member 300 is arranged in the plate shape/thin-walled shape and protrudes towards the front of the pinwheel, such that the accommodating space 302 is formed, in which the connection mechanism 500 can be arranged. As mentioned above, when the projection of the center of gravity of swingable member 300 on the plane 901 coincides with the projection of the center of the block 510 of the connection mechanism 500 on the plane 901 (or the projection of the center of gravity of swingable member 300 on the plane 901 coincides with the projection of the contacting end 540 on the plane 901) and the swingable member 300 is not driven/pushed by any external force, the swingable member 300 remains in the static state shown in FIGS. 1, 2 and 20. In the static state, the connection structure of the swingable member 300 and the central member 100 (e.g., including the connection mechanism 500, the first connection rod 601 and the second connection rod 602) is in the accommodating space 302 of the swingable member 300. When the distance between the swingable member 300 and the rotating members 200 behind the swingable member 300 is close, as shown in FIGS. 1 to 5, 14 and 20, the above-mentioned connection structure is not exposed in people's vision, so that the appearance of the pinwheel is concise, beautiful, and is not adversely affected by the connection structure. Actually, the swing amplitude of the swing member 300 can be reasonably arranged, so that not only in the static state, but also when the swingable member 300 swings in the use process of the pinwheel, the above-mentioned connection structure can be basically hidden and not be exposed in people's vision.

If the swingable member 300 is without the accommodating space 302, taking the swingable member 300 shown in FIG. 21 as an example, not only the connection structure cannot be hidden in the swingable member 300, but also in order to make the projection of the center of the block 510 on a horizontal plane coincides with the projection of the center of gravity of the swingable member 300 on the horizontal plane, the block 510 and the seat 520 need to be arranged above the swingable member 300, as a result, the appearance of the pinwheel is adversely affected, and the appearance of the sunflower flower disc shown in FIGS. 1 and 2 cannot be formed.

In Embodiment 6, the shape of the longitudinal section of the swingable member 300 may be arc-shaped (or approximately arc-shaped) as shown in FIG. 20, or be square. The shape of the longitudinal section of the swingable member 300 is not limited in the present embodiment.

Exemplarily, as shown in FIG. 20, the second connection rod 602 may be linear, the upper end of the second connection rod 602 may be connected to the upper part of the back of the swingable member 300, and the lower end of the second connection rod 602 may be connected to the block 510 of the connection mechanism.

### Embodiment 7

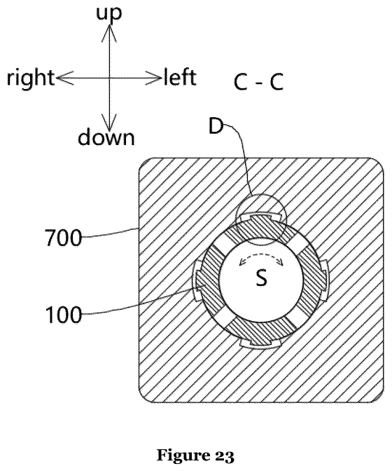

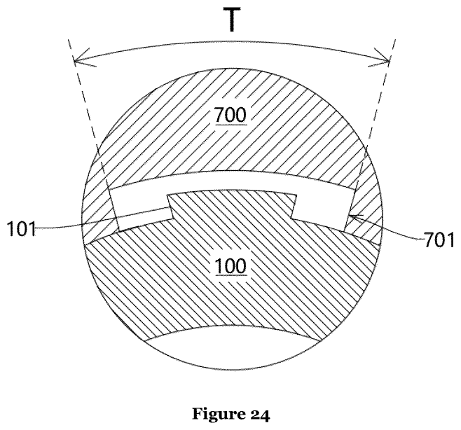

Please referring to FIG. 22, the pinwheel provided in the present disclosure may further include a sleeve 700, in which the second(rear) end of the central member 100 is inserted, such that the central member 100 is rotatable within a preset angle range T as shown in FIGS. 23 and 24. Compared with achieving the swing of the swingable member 300 using the connecting mechanism, the present embodiment provides another way to achieve the swing. In the present embodiment, the central member 100 is arranged to be able to rotate within a preset angle range, so that the swingable member 300 which is connected to the central member 100 can swing within a preset amplitude range with the rotating of the central member 100.

As shown in FIG. 23, the central member 100 can rotate relative to the sleeve 700 towards both sides along the direction S, so that the swingable member 300 can swing in a reciprocating manner about the axis R4 shown in FIG. 22. When seen along the front-rear direction, the rotating of the swingable member 300 around the axis R4 behaves that the left and right ends of the swingable member 300 swing up and down. The swing amplitude of the swingable member 300 is determined by the preset angle range. Exemplarily, as shown in FIG. 24, two opposite side walls of each position limiting groove 701 formed in the sleeve 700 define an exemplary preset angle range T, and the position limiting block 101 arranged on the periphery of the central member 100 can only rotate within this angle range.

In the structure shown in FIG. 24, the swing amplitude of the swingable member 300 is also related to the length of the position limiting block 101. When the length of the position limiting block 101 is larger, the swing amplitude is smaller. In contrary, when the length of the position limiting block 101 is smaller, the swing amplitude is larger. Optionally, as shown in FIG. 23, the number of the position limiting blocks 101 may be four, and they are distributed along the periphery of the central member 100. Correspondingly, the number of the position limiting grooves 701 may be also four, and they are corresponding one-to-one with the position limiting blocks 101.

It can be understood that the structures provided in FIGS. 22 to 24 to achieve the rotation of the central member 100 within the preset angle range are illustrative, and other structures that can be obtained by a person skilled in the art without creative effort are also within the protection scope of the present disclosure. Besides, the way provided in the present embodiment to achieve the swing of the swingable member 300 can be used separately or be used together with other ways to achieve the swing of the swingable member 300 (such as used together with the connection mechanism 500).

### Embodiment 8

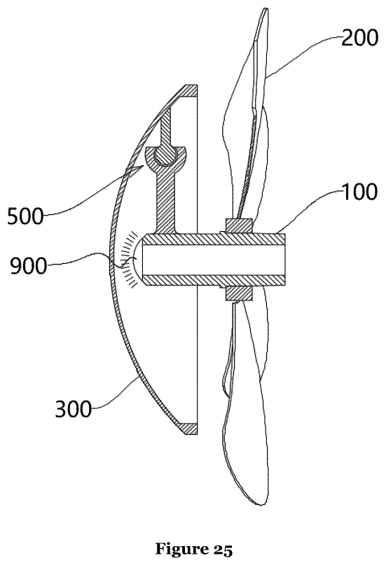

Please referring to FIG. 25, the pinwheel provided in the present disclosure may further include a light source 900, where the central member 100, the swingable member 300 and/or each rotating member 200 is(are) made at least partly of light-penetrable material, such that the pinwheel has luminous effect in whole or in part to further improve the playfulness of the pinwheel.

In the present embodiment, any one, two or all of the central member 100, the rotating members 200 and the swingable member 300 is(are) made of light-penetrable material. In the present embodiment, “made at least partly of light-penetrable material” means that each of them can be made of light-penetrable material partly or entirely.

In the present embodiment, it is not limited where the light source is arranged. In a first example, the light source 900 may be fixed on the central member 100, particularly on the first(front) end of the central member 100 which is close to the swingable member 300, as shown in FIG. 25. In a second example, the light source may be fixed on the surfaces of the rotating members 200 facing towards the swingable member 300. In a third example, the light source may be fixed on the back of the swingable member 300.

### Embodiment 9

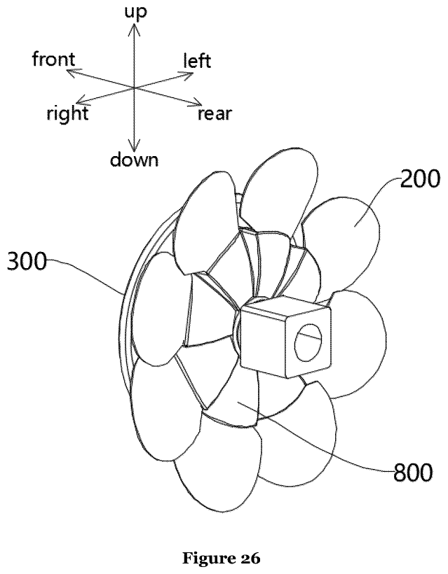

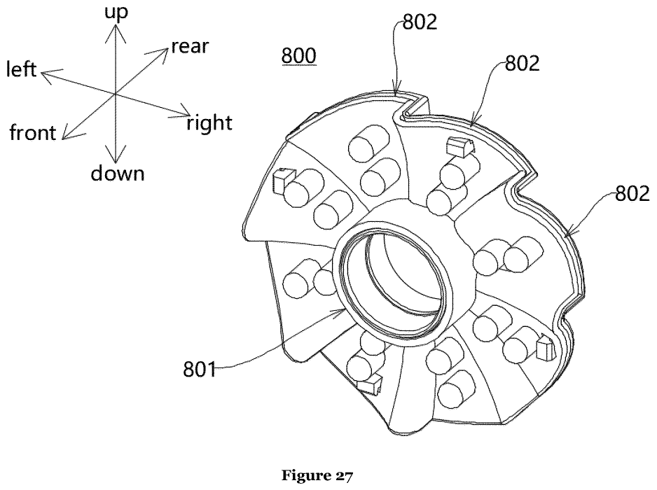

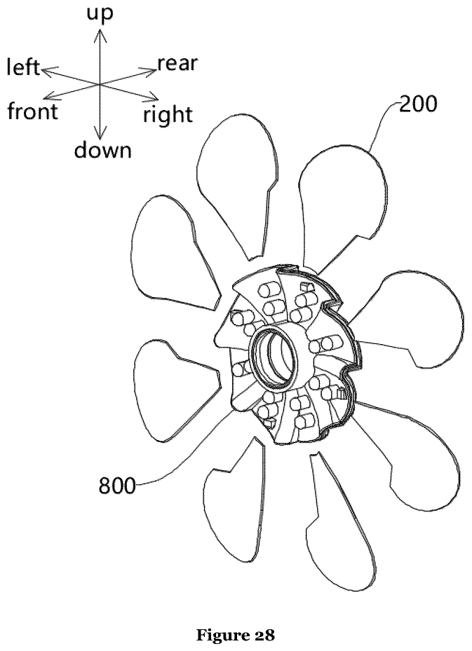

Please referring to FIG. 26, the pinwheel provided in the present disclosure may further include an inserting connection assembly 800. The center of the inserting connection assembly 800 is connected to the central member 100. As shown in FIGS. 27 and 28, the inserting connection assembly 800 is provided with one or more slots 802 distributed along the periphery of the inserting connection assembly 800 and corresponding one-to-one with the rotating members 200. A second end of each rotating member 200 close to the central member 100 is inserted into a corresponding slot 802.

In the present embodiment, a connection structure of the rotating members 200 and the central member 100 is provided. In the present embodiment, the rotating members 200 are connected to the central member 100 through the inserting connection assembly 800. In the present embodiment, one end of each rotating member 200 is inserted into the periphery of the inserting connection assembly 800. The center of the inserting connection assembly 800 may be rotatably connected to the central member 100.

The structure provided in the present embodiment has at least the following three aspects of advantageous effect. In the first aspect, the ends (close to the central member 100) of the rotating members 200 are inserted into the inserting connection assembly 800, such that a flower-like structure is formed (the rotating members 200 form the petals of a flower and the inserting connection assembly 800 forms the central part of the flower) and the playfulness of the pinwheel is improved. In the second aspect, the rotating members 200 are detachably connected to the inserting connection assembly 800, such that the rotating members 200 can be easily replaced, and different rotating members 200 with different shapes can form a variety of appearances thus improving the playfulness of the pinwheel. In the third aspect, the rotating members 200 is detachably connected to the inserting connection assembly 800, such that both can be manufactured separately and be assembled finally, which is conducive to improve the manufacturing efficiency and quality of the pinwheel.

### Embodiment 10

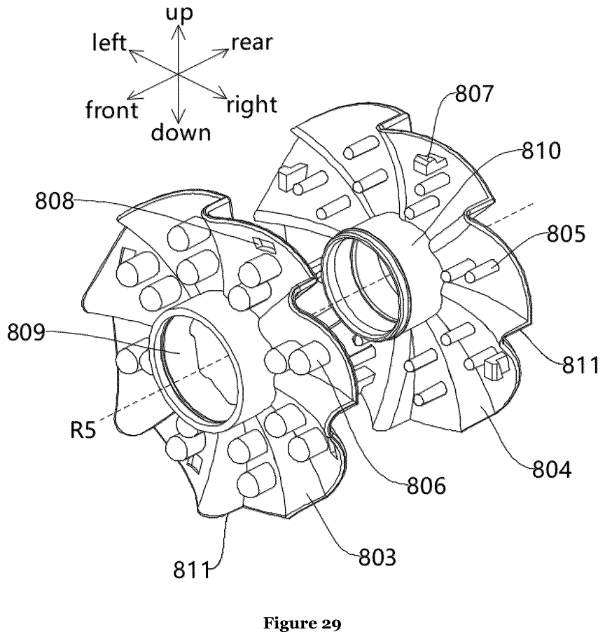

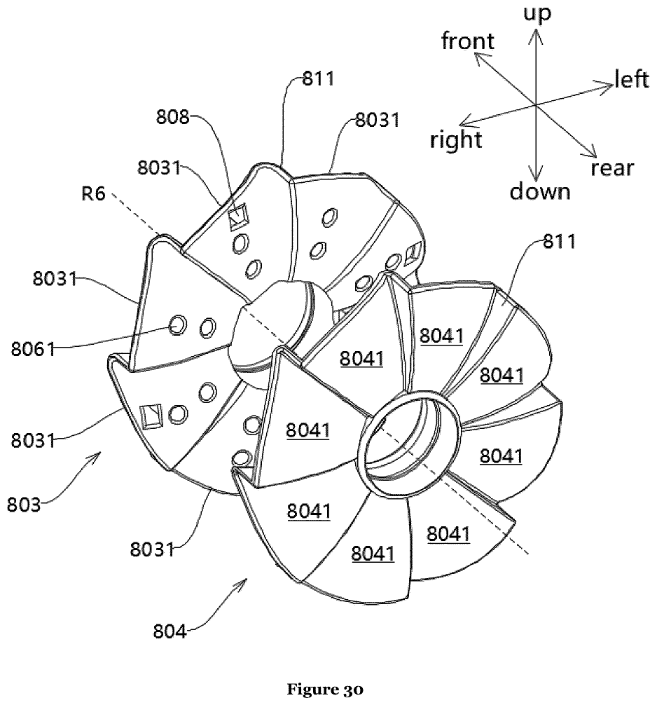

Please referring to FIGS. 29 and 30, the inserting connection assembly 800 may include a front plate 803 and a rear plate 804 detachably connected to the front plate 803. Exemplarily, the front plate 803 may be evenly divided into one or more first visually independent members 8031 distributed along the circumference direction of the front plate 803. The rear plate 804 may be evenly divided into one or more second visually independent members 8041 distributed along the circumference direction of the rear plate 804. The first visually independent members 8031 are corresponding one-to-one with the second visually independent members 8041, and one slot 802 (shown in FIG. 27) is formed between each first visually independent member 8031 and a corresponding second visually independent member 8041.

The structure provided in the present embodiment has at least the following three aspects of advantageous effect. In the first aspect, both the front plate 803 and the rear plate 804 are divided into visually independent members, thus the inserting connection assembly 800 includes visually independent members, such that not only the inserting connection assembly 800, as a whole, forms the central part of the flower-like structure mentioned above, but also each visually independent member forms a petal alone, thus enriching the form of the flower-like structure and increasing the playfulness of the pinwheel. In the second aspect, the front plate 803 is detachably connected to the rear plate 804, such that both can be easily replaced, and different front and rear plate can be easily combined to form a variety of flower appearances thus improving the playfulness of the pinwheel. In the third aspect, the front plate 803 is detachably connected to the rear plate 804, such that both can be manufactured separately and be assembled finally, which is conducive to improve the manufacturing efficiency and quality of the pinwheel.

As shown in FIG. 29, the front plate 803 and the rear plate 804 may form the inserting connection assembly 800 by moving to each other along the axis R5. Similarly, in FIG. 30, the front plate 803 and the rear plate 804 may move to each other along the axis R6 to form the inserting connection assembly 800. When the inserting connection assembly 800 is formed, there are gaps between the front plate 803 and the rear plate 804 along the axis R6. The gap between each first visually independent member 8031 of the front plate 803 and the corresponding second visually independent member 8041 which is aligned with the first visually independent member 8031 forms one of the slots 802. Each slot 802 is configured for being inserted by one of ends (the end close to the central member 100) of each rotating member 200 to realize the connecting of the rotating member 200 and the inserting connection assembly 800.

Exemplarily, as shown in FIGS. 29 and 30, the detachable connection between the front plate 803 and the rear plate 804 and the connection between the rotating members 200 and the inserting connection assembly 800 may be realized through the following structure. Each member 8041 of the rear plate 804 is provided with pins 805 extending forwards, and each member 8031 of the front plate 803 is correspondingly provided with pin hole columns 806, as shown in FIG. 29. Each of the pin hole columns 806 is provided with a pin hole 8061, as shown in FIG. 30. Further, some members 8041 of the rear plate 804 are provided with lock blocks 807, and members 8031 of the front plate 803 are correspondingly provided with lock holes 808, as shown in FIG. 29. The lock blocks 807 are made of elastic material. Please referring to FIG. 29, when the front plate 803 and the rear plate 804 are close to each other along the axis R5 to a certain extent, the lock blocks 807 will be inserted into the lock holes 808. When being inserted into the lock holes 808, the lock blocks 807 deforms by its own elasticity. After inserted, the lock blocks 807 are reset, and the head of each lock block 807 is blocked by the edges of each lock hole 808 and cannot move in the front-rear direction, so that the front plate 803 is fixed relative to the rear plate 804 along the front-rear direction. Besides, each locking block 807 is blocked by the inner walls of each block hole 808, thus the front plate 803 is fixed relative to the rear plate 804 along other directions including the circumferential direction, the up-down direction, and the left-right direction.

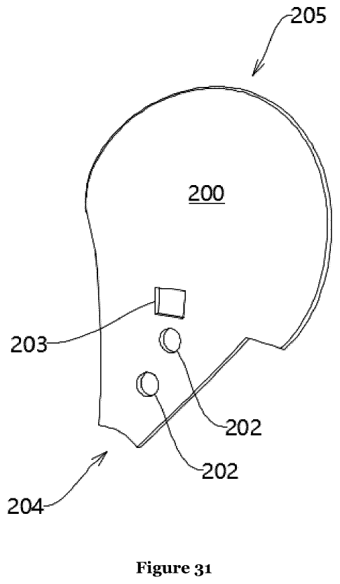

In order to realize the connection between the rotating members 200 and the inserting connection assembly 800, as shown in FIG. 31, each rotating member 200 may be provided with connection holes 202 and a clearance hole 203. The connection holes 202 work together with corresponding pins 805 arranged on the rear plate 804. Each clearance hole 203 is aligned with a corresponding lock block 807, such that the corresponding lock block 807 can pass through the clearance hole 203. Before the front plate 803 and the rear plate 804 move close to each other to achieve locking, all rotating members 200 need to be pre-fixed to the rear plate 804. That is, the rotating members 200 need to be placed in front of the rear plate 804, while the pins 805 arranged on the rear plate 804 need to pass through the connection holes 202 arranged in the rotating members 200 (Besides, if there is the lock block 807, the lock block 807 needs to pass through the clearance hole 203).

After all rotating members 200 are pre-fixed to the rear plate 804, the front plate 803 moves close to the rear plate 804 along the axis R5. Thus, the pins 805 are inserted into the pin hole 8061 of the pin hole column 806 and the lock blocks 807 enter the lock holes 808, such that the connection between the front plate 803 and the rear plate 804 and the connection between the rotating members 200 and the inserting connection assembly 800 are realized. When the connecting is realized/completed, the end close to the central member 100 of each rotating member 200 is in the gap/slot between the front plate 803 and the rear plate 804, meanwhile, the rotating member 200 is fixed by the pins 805, thus the rotating member 200 cannot detach from the gap/slot or move relative to the inserting connection assembly 800.

Exemplarily, the rotating member 200 may be bent, thus the driving force exerted by the walls of the slot of the inserting connection assembly 800 can be applied to the surfaces and sides of the rotating member 200, not just the sides, such that the rotating member 200 has a better effect of withstanding the driving force.

Exemplarily, as shown in FIG. 29, an outer sleeve 809 may be arranged in the central part of the front plate 803, and an inner sleeve 810 may be arranged in the central part of the rear plate 804. The dimension of the outer sleeve 809 is matched with that of the inner sleeve 810. That is, the inner diameter of the outer sleeve 809 is equal to the outer diameter of the inner sleeve 810. In this way, it is convenient for the front plate piece 803 and the rear plate piece 804 to be aligned, thus improving the assembly efficiency of the two.

In the present embodiment, “visually independent member” means that one member can be visually distinguished from other members (e.g., adjacent members). For example, the surface of a disk is divided into several sectors by several straight lines extending along the radii. These sectors are visually independent members of the disk. In FIGS. 29 and 30, each member 8031 and 8041 of the front plate 803 and the rear plate 804 can be visually distinguished from the adjacent members 8031 and 8041 by separators 811 extending in the front-rear direction, such that the visually independent members are formed. Optionally, members 8031, 8041 and separators 811 may be formed in one piece. In FIGS. 29 and 30, the number of the visually independent members of either of the front plate 803 or the rear plate 804 is eight.

As shown in FIG. 26, when seen from the rear of the pinwheel, the inserting connection assembly 800 is exposed in people's vision. The visually independent members distributed in the circumferential direction are like petals and are reminiscent of a flower, thus further improving the playfulness of the pinwheel.

It should be noted that the embodiments provided above and the examples/structures in the embodiments can be combined in a reasonable way to form a new embodiment. For example, the structure like a sunflower disc shown in FIGS. 1, 18 and 19 can be combined with Embodiment 9 which provides the inserting connection assembly 800 to form a new Embodiment 11. In Embodiment 11, the pinwheel provided in the present disclosure may include the central member 100, rotating members 200 and swingable member 300 shown in FIGS. 1 and 2 and the inserting connection assembly 800 shown in FIG. 26. The center of the inserting connection assembly 800 is connected to the central member 100, and the inserting connection assembly 800 is provided with one or more slots 802 (as shown in FIG. 27) which are distributed along the periphery of the inserting connection assembly 800 and corresponding one-to-one with the rotating members 200. Each rotating member 200 is blade-shaped and corresponding with one slot 802, as shown in FIG. 28. As shown in FIGS. 1, 18 and 19, in the front view of the pinwheel, the swingable member 300 is circular or regular polygonal, and the inserting connection assembly 800 is occluded. The first end 205 (shown in FIG. 31 and away from the central member 100) of each rotating member 200 is exposed from the periphery of the swingable member 300. All first ends of the rotating members 200 are distributed along the periphery of the swingable member 300 and evenly surround the swingable member 300. The second end 204 (shown in FIG. 31 and close to the central member 100) of each rotating member 200 is inserted into a corresponding slot 802. In this way, the pinwheel provided in Embodiment 11 has the advantages not only brought by the structure like sunflower disc but also brought by the inserting connection assembly 800.

In Embodiment 11, the rotating members 200 and the inserting connection assembly 800 form the flower-like structure. In addition, various pattern of people or animal expression may be arranged on the surface of the swingable member 300. In this way, when in use, the rotating members 200 rotate and the swingable member 300 swings, and the whole pinwheel is like a vivid living flower, such that the playfulness of the pinwheel is effectively improved.

The above are only preferred embodiments of the present disclosure, and are not intended to limit the present disclosure. Any modifications, equivalent replacements and improvements made within the spirit and principle of the present disclosure shall be included within the protection scope of the present disclosure.

1. A device comprising:
a central member with a first end;
one or more rotating members connected to and rotatable around the central member; and
a swingable member mounted at and swingable with respect to the first end.

2. The device of claim 1, wherein the swingable member is connected to the central member through a connection mechanism, the connection mechanism comprising:
a block connected to one of the central member and the swingable member; and
a seat connected to the other one of the central member and the swingable member, and provided with a constraint cavity;
wherein the block is arranged in the constraint cavity and is rotatable and/or movable.

3. The device of claim 2, wherein the block is provided with a contacting end contacting the constraint cavity.

4. The device of claim 3, wherein the block is provided with a blocking part preventing the block from detaching from the constraint cavity.

5. The device of claim 2, wherein both the block and the constraint cavity are spherical.

6. The device of claim 2, wherein the block is provided with at least one limiting block, the seat is provided with at least one limiting groove corresponding one-to-one with the at least one limiting block, and each of the at least one limiting block is arranged in a corresponding limiting groove of the at least one limiting groove to limit a rotating amplitude and/or a moving amplitude of the block.

7. The device of claim 2, wherein when the device is static, a line defined by a center of the block and a center of gravity of the swingable member is perpendicular to a longitudinal axis of the central member, and a projection of the center of the block on a plane parallel to the longitudinal axis and perpendicular to the line coincides with a projection of the center of gravity of the swingable member on the plane.

8. The device of claim 7, wherein the connection mechanism is connected to the central member through a first connection rod.

9. The device of claim 7, wherein the connection mechanism is connected to the swingable member through a second connection rod.

10. The device of claim 1, wherein the swingable member comprises a first surface and a second surface forming an accommodating space in-between, the first surface is a convex surface curved away from the one or more rotating members, and the second surface faces the one or more rotating members and has an opening through which a first end of the central member extends into the accommodating space.

11. The device of claim 1, wherein a center of the swingable member is aligned with the central member.

12. The device of claim 11, wherein in a front view of the device from the swingable member toward the one or more rotating members, the swingable member is circular or regular polygonal, a first end of each rotating member of the one or more rotating members away from the central member is exposed from a periphery of the swingable member, and first ends of the one or more rotating members are distributed along the periphery of the swingable member and evenly surround the swingable member.

13. The device of claim 1, further comprising a sleeve, wherein a second end of the central member is inserted in the sleeve, such that the central member is rotatable within a preset angle range.

14. The device of claim 1, further comprising a light source, wherein the central member, the swingable member, or each rotating member of the one or more rotating members is made at least partly of light-penetrable material.

15. The device of claim 1, further comprising an inserting connection assembly, wherein a center of the inserting connection assembly is connected to the central member, the inserting connection assembly is provided with one or more slots distributed along a periphery of the inserting connection assembly and corresponding one-to-one with the one or more rotating members, and a second end of each rotating member of the one or more rotating members close to the central member is inserted into a corresponding slot of the one or more slots.

16. The device of claim 15, wherein the inserting connection assembly comprises a front plate and a rear plate detachably connected to the front plate.

17. The device of claim 16, wherein the front plate is evenly divided into one or more first visually independent members distributed along a circumference direction of the front plate, the rear plate is evenly divided into one or more second visually independent members distributed along a circumference direction of the rear plate, the one or more first visually independent members correspond one-to-one with the one or more second visually independent members, and a slot of the one or more slots is formed between each first visually independent member of the one or more first visually independent members and a corresponding second visually independent member of the one or more first visually independent members.

18. The device of claim 1, further comprising an inserting connection assembly, wherein:
a center of the inserting connection assembly is connected to the central member, the inserting connection assembly is provided with one or more slots distributed along a periphery of the inserting connection assembly and corresponding one-to-one with the one or more rotating members;
in a front view of the device from the swingable member toward the one or more rotating members, the swingable member is circular or regular polygonal, the inserting connection assembly is occluded;
a first end of each rotating member of the one or more rotating members away from the central member is exposed from a periphery of the swingable member, first ends of the one or more rotating members are distributed along the periphery of the swingable member and evenly surround the swingable member, and a second end of each rotating member of the one or more rotating members close to the central member is inserted into a corresponding slot of the one or more slots.

19. The device of claim 1, wherein the central member is shaft-shaped.

20. The device of claim 1, further comprising a driver connected to the one or more rotating members and configured to drive the one or more rotating members to rotate around the central member.
